(19) United States
(12) Patent Application Publication
(10) Pub. No.: US 2011/0182612 A1
(43) Pub. Date: Jul. 28, 2011

(54) IMAGE FORMING DEVICE HAVING RETAINING MEMBER THAT CAN BE PULLED OUT THEREFROM

(75) Inventors: Naoya KAMIMURA, Ichinomiya-shi (JP); Shougo SATO, Seto-shi (JP)

(73) Assignee: BROTHER KOGYO KABUSHIKI KAISHA, Nagoya-shi (JP)

(21) Appl. No.: 12/979,482

(22) Filed: Dec. 28, 2010

(30) Foreign Application Priority Data
Jan. 22, 2010 (JP) 2010-012058

(51) Int. Cl. G03G 15/00; G03G 15/04

(52) U.S. Cl. 399/110; 399/119

(57) ABSTRACT

An image forming device includes a casing, photosensitive bodies, developing devices, developer accommodating devices, and a retaining member. The developer accommodating devices includes a first developer accommodating device that is individually replaceable and separable from the corresponding developing device and a second developer accommodating device that is replaceable together with the corresponding developing device. The retaining member retains the photosensitive bodies arranged in an arrangement direction, the developing devices, and the developer accommodating devices at fixed positions within the casing. The retaining member is capable of being pulled out from the casing and is movable between a housed position and a withdrawn position. One of the developer accommodating devices located at a most upstream side in the arrangement direction is the first developer accommodating device, and each of the developer accommodating devices other than the one of the developer accommodating devices is the second developer accommodating device.

### CROSS REFERENCE TO RELATED APPLICATION

This application claims priority from Japanese Patent Application No. 2010-012058 filed Jan. 22, 2010. The entire content of this priority application is incorporated herein by reference.

### TECHNICAL FIELD

The present invention relates in general to an image-forming device for forming images on recording sheets, and more particularly to an image-forming device having a plurality of photosensitive members arranged in tandem and retained together with corresponding developing devices and developer-accommodating devices at fixed positions in a retaining member that can be withdrawn from a body of the image-forming device along the juxtaposed direction of the photosensitive members.

### BACKGROUND

An image-forming device such as a laser printer for forming color images on recording sheets is well known in the art. One such image-forming device has a plurality of photosensitive members and a plurality of corresponding developer cartridges (each integrally formed of a developing device and a developer-accommodating device) arranged in tandem and held at fixed positions within a retaining member. Parts, consumables, and the like in the photosensitive members and the developer cartridges can be replaced by pulling the retaining member out from a body of the image-forming device along the direction in which the photosensitive members are juxtaposed.

### SUMMARY

In order to keep down running costs in a laser printer or other image-forming device, it is beneficial to be able to separate the developer-accommodating devices (toner cartridges) from the developing devices and the photosensitive members so that the developer-accommodating devices can be replaced individually. However, when developing devices having such individually detachable toner cartridges are employed in an image-forming device configured with a retaining member that is pulled out of the image-forming device in the direction of the juxtaposed photosensitive members, the force applied to the extracted retaining member as a result of operations performed to open and close shutters in the toner cartridge when mounting and removing the toner cartridge can potentially damage the retaining member or cause the image-forming device to overturn.

It is an object of the present invention to provide an image-forming device having photosensitive members arranged in tandem in a retaining member that can be pulled out of a body of the image-forming device along the juxtaposing direction of this tandem arrangement, whereby one of the developing devices provided in the retaining member has an individually detachable toner cartridge for reducing running costs and the configuration eliminates the risk of damaging the retaining member and overturning the body of the image-forming device due to forces applied to the retaining member when the retaining member is partially withdrawn from the body.

In order to attain the above and other objects, the invention provides an image forming device. The image forming device includes a casing, a plurality of photosensitive bodies, a plurality of developing devices, a plurality of developer accommodating devices, and a retaining member. The casing is formed with an opening. The plurality of developing devices respectively corresponds to the plurality of photosensitive bodies. The plurality of developer accommodating devices accommodates and supplies developer respectively to the plurality of developing devices. The plurality of developer accommodating devices includes a first developer accommodating device that is individually replaceable and separable from the corresponding developing device and a second developer accommodating device that is replaceable integrally together with the corresponding developing device. The retaining member retains the plurality of photosensitive bodies arranged in an arrangement direction, the plurality of developing devices, and the plurality of developer accommodating devices at fixed positions in the casing. The retaining member is capable of being pulled out from the casing in the arrangement direction through the opening and is movable between a first position where the plurality of photosensitive bodies, the plurality of developing devices, and the plurality of developer accommodating devices are inside the casing and a second position where one of the plurality of developer accommodating devices located at most upstream side in the arrangement direction is replaceable. The one of the plurality of developer accommodating devices located at the most upstream side in the arrangement direction is the first developer accommodating device accommodating black developer. Each of the developer accommodating devices other than the one of the plurality of developer accommodating devices is the second developer accommodating device.

### BRIEF DESCRIPTION OF THE DRAWINGS

The particular features and advantages of the invention as well as other objects will become apparent from the following description taken in connection with the accompanying drawings, in which:

FIG. 1 is a cross-sectional view showing a color multifunction device according to an embodiment of the present invention;

FIG. 2 is a cross-sectional view illustrating a state in which a retaining case is at a first position where the retaining case is inside a main body of the color multifunction device;

FIG. 3 is a cross-sectional view illustrating a state in which the retaining case is at a second position where the retaining case is pulled out from the main body;

FIG. 4 is a cross-sectional view illustrating an operation in which process units are replaced;

FIG. 5 is a perspective view showing a toner cartridge and a developing device when shutters are at a closed position;

FIG. 6 is a perspective view showing the toner cartridge and the developing device when the shutters are at an open position;

FIG. 7(a) is a explanatory diagram conceptually illustrating a configuration ambient to a rear end of the retaining case in the main body when the process units are replaced; and

FIG. 7(b) is an explanatory diagram conceptually illustrating a configuration ambient to a front end of the retaining case in the main body when the process units are replaced.

### DETAILED DESCRIPTION

Next, an embodiment of the present invention will be described while referring to the accompanying drawings. The following description first covers the overall structure of a color multifunction device of the embodiment according to the present invention and subsequently includes a detailed description of a process unit having a developer-accommodating device accommodating black developer.

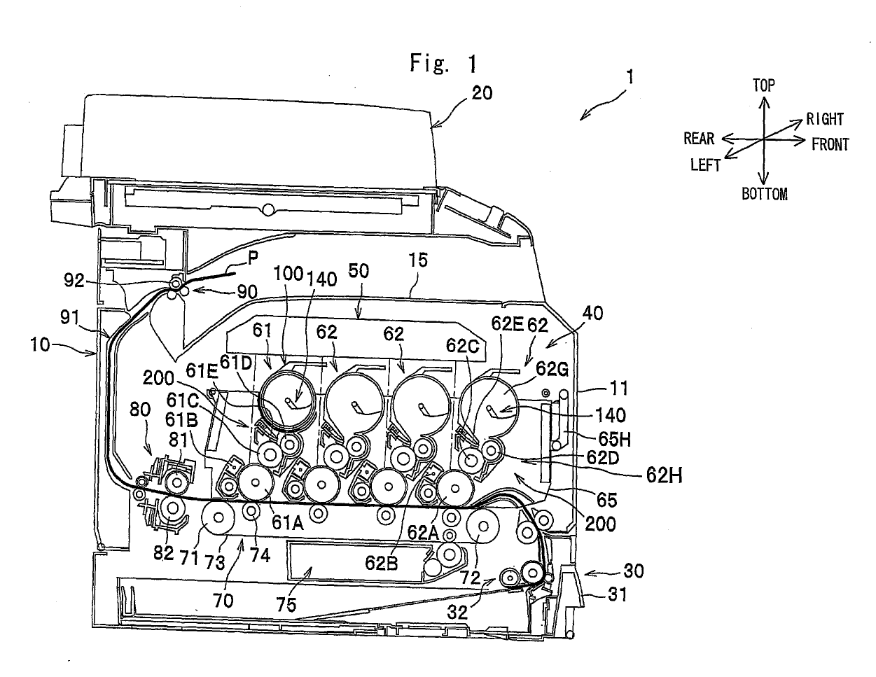

As shown in FIG. 1, a color multifunction device 1 has a main body 10 and a flatbed scanner. 20 disposed above the main body 10. Within the main body 10, the color multifunction device 1 primarily includes a sheet-feeding unit 30 for supplying sheets of a paper P, an image-forming unit 40 for forming images on sheets of paper P supplied by the sheet-feeding unit 30, and a sheet-discharging unit 90 for discharging the sheets of paper P after images have been formed thereon.

In the following description, directions related to the color multifunction device 1 will refer to directions seen from the perspective of an operator when operating the color multifunction device 1. Specifically, the right side of the color multifunction device 1 in FIG. 1 will be referred to as the “front” or the “near side”; the left side as the “rear” or the “far side”; the near side in FIG. 1 as “left”; and the far side in FIG. 1 as “right.” Also, the upper and lower sides along the vertical in FIG. 1 will be referred to as “upper” and “lower” in the description.

The flatbed scanner 20 disposed above the main body 10 is a document-reading device well known in the art. During a copy operation and the like, the flatbed scanner 20 generates image data by irradiating light onto an original document placed in the flatbed scanner 20 and reads the image from the original document.

The sheet-feeding unit 30 is disposed in a bottom section of the main body 10 and includes a paper tray 31 for accommodating sheets of paper P, and a paper-feeding mechanism 32 for conveying sheets of paper P from the paper tray 31 to the image-forming unit 40. The paper-feeding mechanism 32 separates and conveys the paper P accommodated in the paper tray 31 to the image-forming unit 40 one sheet at a time.

The image-forming unit 40 primarily includes an exposure unit 50, four process units including a process unit 61 and three process units 62, a transfer unit 70, and a fixing unit 80.

The exposure unit 50 is provided in a top section of the main body 10 and includes a laser light source, a polygon mirror, lenses, reflecting mirrors, and the like (not shown in the drawings). Laser beams emitted from the laser light source are reflected off the polygon mirror and the reflecting mirrors, pass through the lenses, and are scanned at a high speed over surfaces of photosensitive drums described later.

The process unit 61 and the process units 62 are disposed between the sheet-feeding unit 30 and the exposure unit 50 and are juxtaposed (arranged in tandem) in the front-to-rear direction. The process units 61 and 62 are held in a retaining case 65.

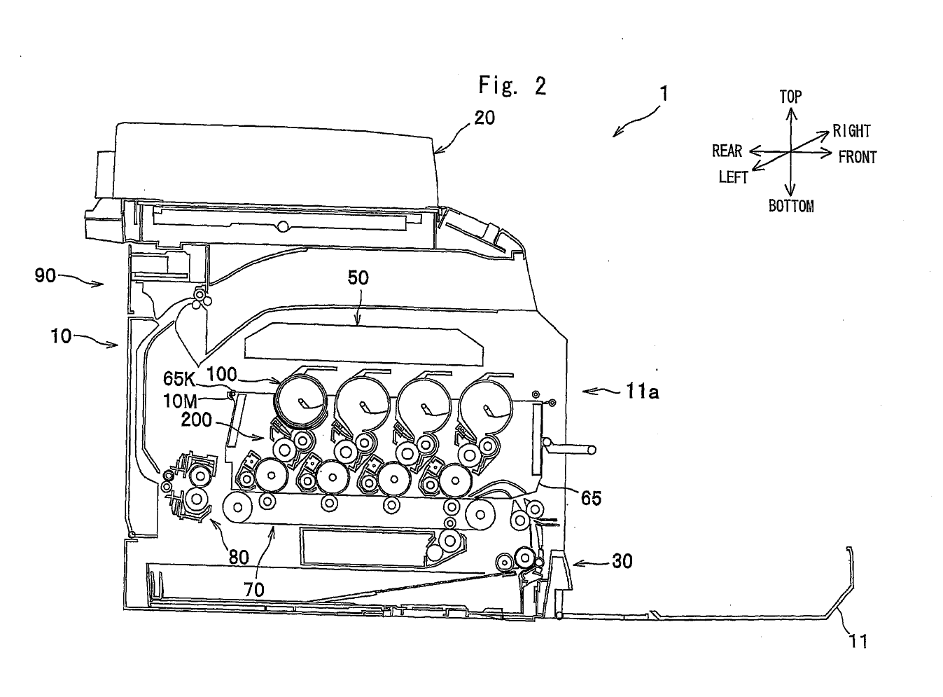

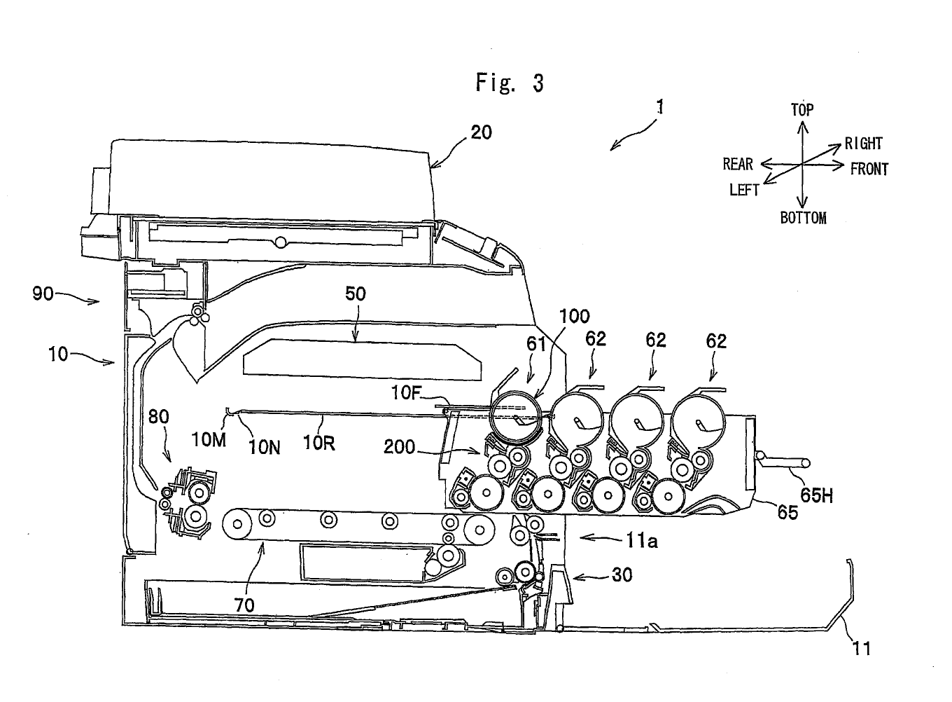

The retaining case 65 has a bottomless frame-like structure, for example, and is capable of moving between a first position where the retaining case 65 is mounted in the main body 10 (see FIG. 2) and a second position where the retaining case 65 is removed forwardly from the main body 10, i.e., the process unit 61 is within the main body 10 and the process units 62 are outside the main body 10 while the retaining case 65 retains the process units 61 and 62 (see FIG. 3). Guide rails 10R (see FIG. 3) are formed on inner sides of the main body 10 for guiding the retaining case 65 in the front-to-rear direction. A front cover 11 is provided on a front side of the main body 10 over an opening 11a formed in the main body 10 and can be pivotally rotated downward to expose the opening 11a or upward to cover the opening 11a. A handle 65H is provided on a front end of the retaining case 65. By opening the front cover 11 and pulling on the handle 65H, an operator can pull the retaining case 65 out of the main body 10 in a pull-out direction through the opening 11a, i.e., moves the retaining case 65 to the second position, as illustrated in FIG. 3. Once the retaining case 65 has been positioned at the second position, the operator can replace components of the process units 61 and 62 that, during their normal operating state, are positioned far side (rearward) of the main body 10. That is, the second position indicates the position of the retaining case 65 at which the developer-accommodating device (a toner cartridge 100) of the process unit 61 disposed farthest inward in the retaining case 65 among the four process units 61 and 62 with respect to the pull-out direction can be accessed and replaced.

The structure for enabling the operation to pull the retaining case 65 outward with respect to the main body 10 and to support the retaining case 65 while maintaining the retaining case 65 in either the first position or the second position will be described later in greater detail.

As shown in FIG. 1, the process unit 61 disposed on a farthest side of the retaining case 65 among the four process units 61 and 62 includes a photosensitive drum 61A, a charger 61B, the toner cartridge 100 accommodating black toner, and a developing device 200. The developing device 200 includes a developing roller 61C, a supply roller 61D, and a thickness-regulating blade 61E. The structure of the process unit 61 will be described later in greater detail.

The photosensitive drum 61A and the charger 61B of the process unit 61 may be configured so that they are mounted in and removed from the retaining case 65 together (i.e., replaceable as a unit) or may be fixed to the retaining case 65 to form a single unit therewith. Alternatively, the developing roller 61C, the supply roller 61D, and the thickness-regulating blade 61E constituting the developing device 200 may be configured as an integrated unit that is mounted in and removed from the retaining case 65, or may be fixed to the retaining case 65 together with the photosensitive drum 61A and the charger 61B and formed as a single unit with the retaining case 65. If the developing device 200 is detachably mounted in the retaining case 65, the photosensitive drum 61A and the charger 61B may be configured to be detachably mounted as a unit or to be mounted and removed separately.

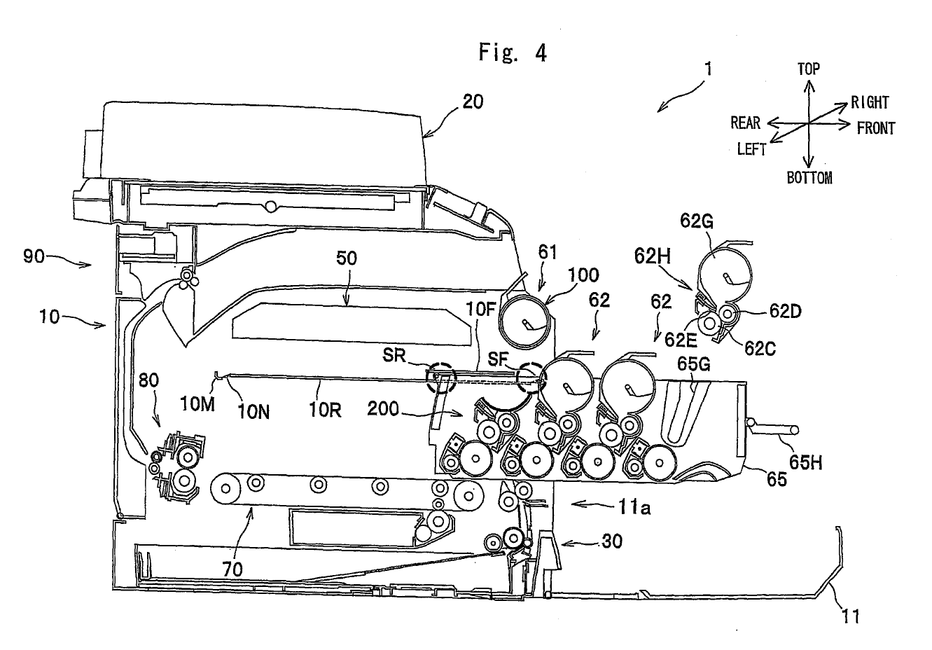

Each of the three process units 62 among the four process units disposed nearer frontward in the retaining case 65 includes a photosensitive drum 62A, a charger 62B, a developing roller 62C, a supply roller 62D, a thickness-regulating blade 62E, and a developer-accommodating device 62G. The developer-accommodating devices 62G of these process units 62 accommodate toner in one of the colors cyan, magenta, and yellow, respectively. A developing device 62H of each process unit 62 is configured of the developing roller 62C, the supply roller 62D, and the thickness-regulating blade 62E and is integrally configured with the developer-accommodating device 62G and detachably mounted in the retaining case 65 (see FIG. 4).

As with the photosensitive drum 61A and the charger 61B of the process unit 61, the photosensitive drum 62A and the charger 62B of the process unit 62 may be configured to be detachably mounted in the retaining case 65 (i.e., replaceable) or fixed to the retaining case 65 to form a single unit therewith. The process unit 62 (i.e., the photosensitive drum 62A, the charger 62B, the developing roller 62C, the supply roller 62D, the thickness-regulating blade 62E, and the developer-accommodating device 62G) may be detachably mounted in the retaining case 65 as a unit.

The transfer unit 70 is disposed between the sheet-feeding unit 30 and the process units 61 and 62. The transfer unit 70 primarily includes a drive roller 71, a follow roller 72, an endless conveying belt 73 stretched taut about the rollers 71 and 72, and four transfer rollers 74. The outer surface of the conveying belt 73 is in contact with each of the photosensitive drums 61A and 62A and is pinched between the transfer rollers 74 disposed on the inner side of the conveying belt 73 and the photosensitive drums 61A and 62A.

A cleaning unit 75 is disposed beneath the conveying belt 73. The cleaning unit 75 contacts the conveying belt 73 for removing toner, paper dust, and other deposited matter from the conveying belt 73 and for recovering this deposited matter.

The fixing unit 80 is disposed rearward of the process units 61 and 62 and the transfer unit 70. The fixing unit 80 primarily includes a heating roller 81, and a pressure roller 82 disposed in confrontation with the heating roller 81 and applying pressure to the same.

In the image-forming unit 40, the chargers 61B and 62B apply a uniform charge to the respective surfaces of the photosensitive drums 61A and 62A, after which the surfaces are exposed to laser beams emitted from the. exposure unit 50 in a high-speed scan to form electrostatic latent images on the charged surfaces of the photosensitive drums 61A and 62A based on image data. Toner accommodated in the toner cartridge 100 and the developer-accommodating devices 62G is supplied respectively to the developing rollers 61C and 62C via the supply rollers 61D and 62D. As the developing rollers 61C and 62C rotate, toner carried on the surfaces of the same is regulated to a prescribed thickness by the respective thickness-regulating blades 61E and 62E.

The toner layers of uniform thickness carried on the developing rollers 61C and 62C are supplied to the electrostatic latent images formed on the photosensitive drums 61A and 62A, respectively, whereby the electrostatic latent images are developed into visible toner images on the photosensitive drums 61A and 62A. Subsequently, as a sheet of paper P carried on the conveying belt 73 is sequentially conveyed between the photosensitive drums 61A and 62A and the conveying belt 73 (the transfer rollers 74), the toner images carried on the photosensitive drums 61A and 62A are sequentially transferred onto and superposed on the sheet of paper P. When the sheet of paper P is then conveyed between the heating roller 81 and the pressure roller 82, the toner images transferred on the sheet are fixed to the sheet by heat.

The sheet-discharging unit 90 primarily includes a paper-discharge path 91 for guiding sheets of paper P upward in the main body 10 from the exit side of the fixing unit 80 while inverting the sheets, and a discharge roller 92 for discharging the inverted sheets onto a discharge tray 15 formed on top of the main body 10. Thus, after the toner images are fixed to the sheet of paper P by heat in the fixing unit 80, the sheet is conveyed from the fixing unit 80 into the paper-discharge path 91, and the discharge roller 92 discharges the sheet onto the discharge tray 15.

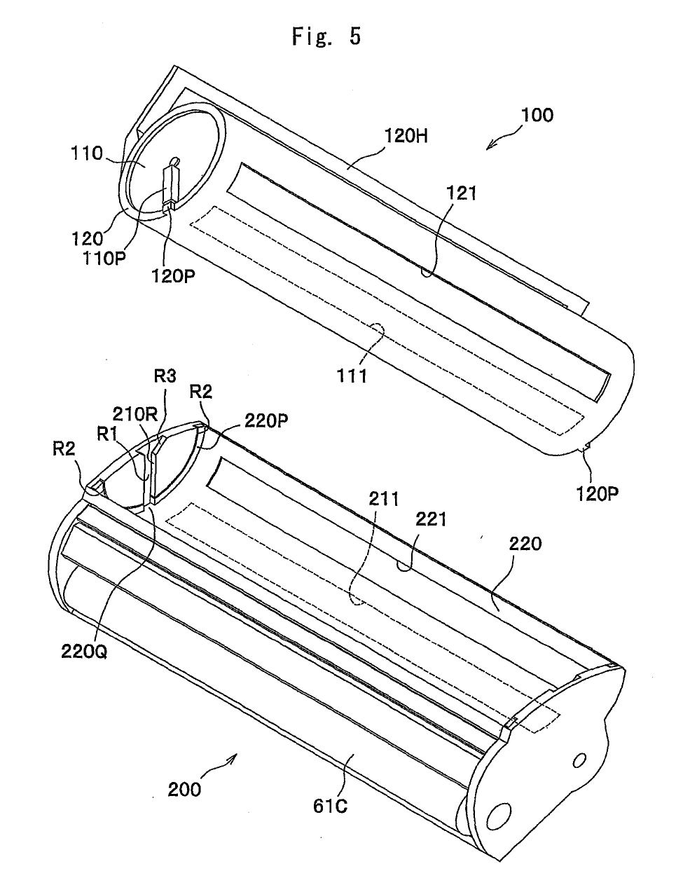

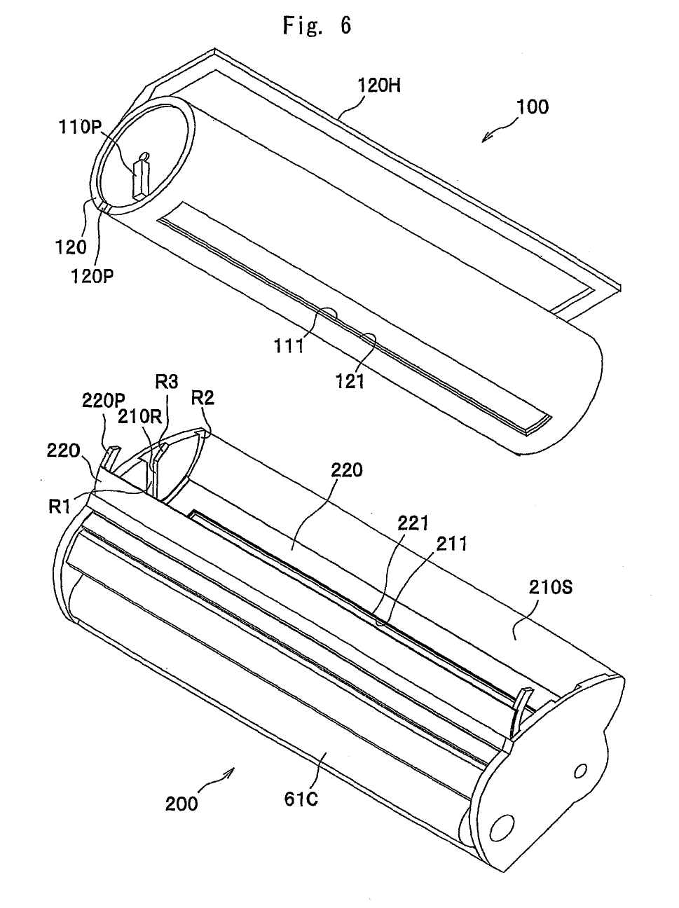

Next, the structure of the process unit 61 (the toner cartridge 100 and the developing device 200) will be described in detail and contrasted with the process units 62 while referring primarily to FIGS. 5 and 6. FIGS. 5 and 6 show a bottom view of the toner cartridge 100 and a top view of the developing device 200.

As shown in FIGS. 3 and 4, the toner cartridge 100 of the process unit 61 is detachably mounted on the developing device 200. When mounted on the developing device 200, the toner cartridge 100 is positioned above and adjacent to the developing device 200.

As shown in FIGS. 5 and 6, the toner cartridge 100 is a substantially cylindrical container with side walls 110 closing both left and right ends thereof. The cylindrically shaped wall of the toner cartridge 100 is formed with a first supply opening 111 for supplying toner from the toner cartridge 100 to the developing device 200.

A cylindrical first shutter 120 is provided on the toner cartridge 100 around the cylindrical wall of the toner cartridge 100. By rotating the first shutter 120 in a circumferential direction relative to the toner cartridge 100, the shutter 120 can open and close the first supply opening 111. Specifically, a first shutter supply opening 121 is formed in the first shutter 120 at a position that perfectly overlaps the first supply opening 111 formed in the toner cartridge 100 when the first shutter 120 is in an open position illustrated in FIG. 6. When the first shutter 120 is rotated a prescribed stroke in the circumferential direction relative to the toner cartridge 100 to a closed position illustrated in FIG. 5, the first shutter 120 completely blocks the first supply opening 111.

A ridge part 110P is provided on each of the left and right side walls 110 of the toner cartridge 100. The ridge parts 110P extend radially from the center of the side walls 110 to the outer edge thereof and have a rectangular cross section. Protruding parts 120P having the same cross-sectional shape as the ridge parts 110P are provided on longitudinal ends of the first shutter 120.

When the first shutter 120 is set in the closed position as shown in FIG. 5, the protruding parts 120P are aligned with the outer ends of the corresponding ridge parts 110P, forming continuous guide rails for guiding the toner cartridge 100 when the toner cartridge 100 is mounted on the developing device 200 described later. When the first shutter 120 is rotated to the open position while the toner cartridge 100 is attached to the developing device 200, the protruding parts 120P move circumferentially within second groove parts R2 (described later in greater detail) formed in side walls of the developing device 200 so that the toner cartridge 100 is engaged (interlocked) with the developing device 200 (see FIG. 6).

A handle 120H is provided on the peripheral surface of the first shutter 120. The handle 120H extends horizontally rearward from an upper portion of the first shutter 120 when the toner cartridge 100 is mounted on the developing device 200 (i.e., when the first shutter 120 is in the open position), as shown in FIG. 1. When the operator grips the handle 120H and rotates the handle 120H from this horizontal position upward relative to the mounted toner cartridge 100, the first shutter 120 is rotated to the closed position, disengaging (unlocking) the toner cartridge 100 from the developing device 200 so that the toner cartridge 100 can be removed (see FIG. 3).

Further, an agitator 140 well known in the art is provided inside the toner cartridge 100 (see FIG. 1). The agitator 140 is primarily configured of a rotational shaft rotatably supported in the left and right side walls 110, and a plurality of sheet-like agitating blades. The agitating blades are formed of a flexible material and are fixed to the rotational shaft.

A motor (not shown) provided in the main body 10 applies a drive force to the rotational shaft for rotating the agitator 140 in the toner cartridge 100. When the rotational shaft rotates, the distal edges of the agitating blades slanted relative to the rotational shaft scrape against the inner surface of the toner cartridge 100, agitating toner in the toner cartridge 100 and conveying this toner toward the first supply opening 111.

As shown in FIG. 1, the developing device 200 is provided with the developing roller 61C, the supply roller 61D, the thickness-regulating blade 61E, and the like. The structure and arrangement of the developing device 200 is similar to the developing device 62H of the process units 62, except that the toner cartridge 100 is detachably mounted on the developing device 200 as the developer-accommodating device, and an accommodating recessed part 210S (see FIG. 6) for receiving the mounted toner cartridge 100 is formed in the developing device 200 at a position opposing the supply roller 61D.

As shown in FIGS. 5 and 6, a second supplying opening 211 is formed in a curved wall of the developing device 200 forming the arch shape (arc-shaped in a cross section) of the accommodating recessed part 210S at a position corresponding to the first supply opening 111 formed in the toner cartridge 100. The second supplying opening 211 functions to supply toner from the toner cartridge 100 to the developing device 200.

A second shutter 220 is also provided in the developing device 200 around the arch-shaped wall of the accommodating recessed part 210S. By rotating in a circumferential direction relative to the accommodating recessed part 210S, the second shutter 220 can open and close the second supplying opening 211 formed in the accommodating recessed part 210S. More specifically, a second shutter supply opening 221 is formed in the second shutter 220 at a position that is perfectly aligned with the second supplying opening 211 formed in the developing device 200 when the second shutter 220 is in an open position (see FIG. 6). By rotating the second shutter 220 a prescribed stroke in the circumferential direction relative to the developing device 200 to a closed position, the second shutter 220 completely blocks the second supplying opening 211 (see FIG. 5).

A grooved part 210R is formed on the inside surface of each of the left and right walls of the accommodating recessed part 210S. The grooved part 210R includes a first groove part R1 extending radially downward from the center of curvature of the accommodating recessed part 210S, a second groove part R2 following circumferential directions (both forward and rearward) from the bottom end of the first groove part R1, and a funnel-shaped part R3 formed at the top of the first groove part R1 in a funnel shape that widens toward the top in order to facilitate insertion of the ridge part 110P and the protruding part 120P when mounting the toner cartridge 100 in the accommodating recessed part 210S.

An inner circumferential protruding part 220P is formed on each of the left and right ends of the second shutter 220 for slidably engaging in the second groove parts R2. A notched part 220Q is formed in the inner circumferential protruding part 220P in a portion opposing the bottom end of the first groove part. R1 when the second shutter 220 is at the closed position so that the protruding part 120P can be inserted into the notched part 220Q when mounting the toner cartridge 100 (see FIG. 5).

While chemical toner is used for the color toner accommodated in the developer-accommodating devices 62G of the process units 62 in the embodiment, pulverized toner is used for the black toner accommodated in the toner cartridge 100 of the process unit 61.

Here, “chemical toner” denotes toner that is manufactured according to chemical processes, in contrast to the traditional toners that are manufactured through a mechanical pulverizing process. Chemical toner can be produced through a variety of methods, including emulsion polymerization and aggregation, suspension polymerization, emulsion aggregation, and dissolution suspension. “Pulverized toner” includes not only traditional toner manufactured according to a mechanical pulverizing process, but also to the same toner that has been chemically treated to produce rounder toner particles.

By employing pulverized toner, which has lower fluidity than chemical toner, it is possible to reduce the likelihood of toner leaking from the developing device 200 and to extend the service life of the developing device 200 in terms of the number of printed sheets, since the service life is greatly dependent on the lifespan of the toner leakage preventing seal.

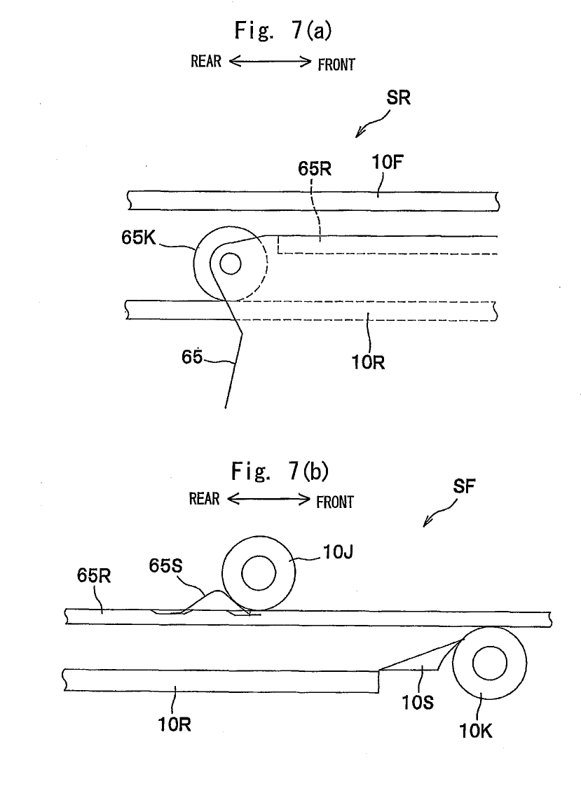

Next, the structure for enabling the retaining case 65 to be pulled outward from the main body 10 and for supporting the retaining case 65 in fixed positions will be described with reference to FIGS. 2 through 4 and FIGS. 7(a) and 7(b). FIGS. 7(a) and 7(b) are explanatory diagrams conceptually illustrating a rear supporting structure SR and a front supporting structure SF when the retaining case 65 is at the second position shown in FIG. 4.

A flange part 65R is provided on each of the left and right walls of the retaining case 65. The flange parts 65R extend along the walls in the front-to-rear direction and are formed by bending the upper edges of the side walls outward. As shown in FIG. 7(a), rollers 65K are provided on the rear end of the retaining case 65 rearward of the flange parts 65R.

Guide rails 10R are provided in the main body 10 on left and right sides of the space provided for accommodating the retaining case 65. The guide rails 10R serve to guide the retaining case 65 in the pull-out direction while maintaining the retaining case 65 in a horizontal orientation. As shown in FIG. 7(b), a sloped part 10S and a roller 10K are provided on the front end of each guide rail 10R, and a roller 10J is disposed slightly rearward and above the sloped part 10S and the roller 10K on each side.

As shown in FIGS. 3, 4, and 7(a), a restricting frame 10F is provided in the main body 10 on each of the left and right sides of the space accommodating the retaining case 65. The restricting frames 10F run parallel to the guide rails 10R and restrict the retaining case 65 from moving the flange parts 65R upward at least for the region of the rear supporting structure SR when the retaining case 65 is in the second position.

As shown in FIGS. 2 and 3, a sloped part 10N and a positioning part 10M are provided on the rear end of each of the guide rails 10R.

When the retaining case 65 is in the first position shown in FIG. 2, the rollers 65K on the rear end of the retaining case 65 are accommodated in the positioning parts 10M provided on the main body 10 and are fixed in position by the same. At this time, the flange parts 65R of the retaining case 65 rest on the guide rails 10R of the main body 10 and are stably supported in a fixed position by the same. Operations of the color multifunction device 1 can be performed when the retaining case 65 is in this position.

When the retaining case 65 is pulled outward from this position, the rollers 65K provided on the rear end of the retaining case 65 roll up the sloped parts 10N onto the guide rails 10R, while the flange parts 65R at the front end of the retaining case 65 slide up the sloped parts 10S and pass over the rolling rollers 10K, thereby guiding the retaining case 65 forward.

When the retaining case 65 arrives at the second position shown in FIG. 3, leaf springs 65S mounted on the flange parts 65R contact the rollers 10J on the main body 10, and this contact halts movement of the retaining case 65 in the pull-out direction. In this position, the operator can replace the toner cartridge 100 of the process unit 61 and the developer-accommodating devices 62G (and the developing rollers 62C, the supply rollers 62D, and the thickness-regulating blades 62E) of the process units 62.

As shown in FIGS. 3 and 4, the process unit 61 is still positioned within the main body 10 when the retaining case 65 is in the second position. At the same time, the process unit 61 is positioned between the front supporting structure SF and the rear supporting structure SR, and the retaining case 65 is supported in the main body 10 at the front supporting structure SF and the rear supporting structure SR.

Specifically, since the rollers 65K are resting on the guide rails 10R, as shown in FIG. 7(a), downward movement of the retaining case 65 is restricted. Further, the restricting frames 10F disposed above the rollers 65K and the flange parts 65R restrict upward movement of the retaining case 65.

As shown in FIG. 7(b), downward movement of the retaining case 65 is restricted since the flange parts 65R rest on the rollers 10K, and upward movement is restricted since the rollers 10J are positioned above the flange parts 65R.

The leaf springs 65S serving to fix the retaining case 65 in the second position have center regions that bulge gently upward. The front ends of the leaf springs 65S are embedded in the corresponding flange parts 65R while the rear ends can slide into recessed parts formed in the top surfaces of the corresponding flange parts 65R. Hence, if the user exerts greater force to pull the retaining case 65 farther forward from the state shown in FIG. 7(b), the leaf springs 65S are configured to elastically deform and pass beneath the rollers 10J as the retaining case 65 moves forward.

When the user pulls the retaining case 65 past the second position, the rollers 65K on the rear end of the retaining case 65 pass over the corresponding sloped parts 10S and the rollers 10K, allowing the retaining case 65 to be completed removed from the main body 10. Thus, the operator can repair or replace the photosensitive drums 61A and 62A, the chargers 61B and 62B, and the like after removing the retaining case 65 in this way.

Next, operations for replacing the toner cartridge 100 in the process unit 61 having the above construction will be described.

When the process unit 61 is positioned as shown in FIGS. 1 and 2, the toner cartridge 100 is engaged with the developing device 200, and the first shutter 120 and the second shutter 220 are at the open position. In other words, as shown in FIG. 6, the protruding part 120P of the first shutter 120 is at a position offset from the ridge part 110P and is inset in the second groove part R2. Thus, the mounted toner cartridge 100 is firmly and inseparably fixed to the developing device 200.

When the toner cartridge 100 is out of black toner or needs to be replaced for any reason, the operator first opens the upper cover 12, grips the handle 120H, and then pulls the retaining case 65 forward until the retaining case 65 becomes fixed in the second position. When the handle 120H is rotated rearward (counterclockwise direction in FIG. 1), the first and second shutters 120 and 220 on the toner cartridge 100 and the developing device 200 are closed and the toner cartridge 100 is disengaged from the developing device 200 (see FIG. 3). Next, the operator extracts the toner cartridge 100 upward through the opening 11a.

More specifically, the operation to rotate the handle 120H rearward shifts the first shutter 120 and the second shutter 220 from the position shown in FIG. 6 to the position shown in FIG. 5, causing the first shutter 120 and the second shutter 220 to shift to the closed position and the protruding parts 120P of the first shutter 120 to arrive at a position aligned with the ridge parts 110P. Consequently, the protruding parts 120P can pass through the respective first groove parts R1 which are the portion of the grooved parts 210R that extend radially, thereby enabling the operator to pull the toner cartridge 100 upward, as illustrated in FIG. 4.

To mount a new toner cartridge 100 in the process unit 61, the operator first opens the front cover 11, then pulls the retaining case 65 forward until the retaining case 65 becomes fixed in the second position shown in FIG. 3. Subsequently, the operator mounts the new toner cartridge 100.

During this operation, the operator aligns the ridge parts 110P and the protruding parts 120P on left and right sides of the toner cartridge 100 in the state shown in FIG. 5 with the grooved parts 210R on the left and right sides of the developing device 200 and inserts the ridge parts 110P and the protruding parts 120P in the corresponding grooved parts 210R until the entire toner cartridge 100 is seated in the accommodating recessed part 210S of the developing device 200. Subsequently, the operator rotates the handle 120H forward (clockwise direction in FIG. 1), moving the first shutter 120 and the second shutter 220 to their open positions shown in FIG. 6.

Through this operation, the protruding parts 120P of the first shutter 120 enter the respective second groove parts R2 of the grooved parts 210R and move to a position offset from the respective ridge parts 110P. Accordingly, the mounted toner cartridge 100 is firmly fixed to and inseparable from the developing device 200.

Since the second shutter 220 of the developing device 200 opens and closes the second supplying opening 211 in association with the handle 120H opening and closing the first shutter 120, both the first shutter 120 and the second shutter 220 are easily opened and closed through a single operation. Further, the toner cartridge 100 is disengaged from the developing device 200 in association with the operation of the handle 120H to switch these shutters 120 and 220 to their closed positions and is engaged with the developing device 200 in association with the operation of the handle 120H to switch the shutters 120 and 220 to their open positions, thereby achieving both safety and simplicity of operations.

When one of the developer-accommodating devices 62G of the process units 62 must be replaced together with the developing device 62H (i.e., the developing roller 62C, the supply roller 62D, and the thickness-regulating blade 62E) because the developer-accommodating device 62G has run out of cyan, magenta, or yellow toner, for example, the operator opens the front cover 11, grips the handle 65H, and pulls the retaining case 65 forward to the second position and replaces the relevant components, as illustrated in FIG. 4.

Here, the retaining case 65 may be completely separately removed from the main body 10 before replacing the components of the process units 61 and 62.

As shown in FIG. 4, guide grooves 65G are formed in the inner surfaces of both side walls constituting the retaining case 65. The guide grooves 65G function to guide the vertical sliding movement of the developer-accommodating devices 62G and the developing devices 62H when they are mounted in the retaining case 65 and to maintain the mounted developing devices 62H (particularly the developing rollers 62C) at a fixed position in the bottom ends of the guide grooves 65G. This construction for mounting and removing the developer-accommodating devices 62G and the developing device 62H facilitates the smooth replacement of components in the process units 62.

The color multifunction device 1 according to the embodiment having the construction described above primarily produces the following advantages and effects.

As described above, the color multifunction device 1 has the drawer-like retaining case 65 for accommodating the plurality of developer-accommodating devices in tandem. Of these developer-accommodating devices, the toner cartridge 100 that accommodates black developer is detachably mounted in the process unit 61 disposed in the farthest position of the retaining case 65 relative to the pull-out direction. Since this position affords the most stable operations when the retaining case 65 is fixed in the second position, replacement of the toner cartridge 100 accommodating black developer is both easy and safe, and running costs can be reduced.

Further, the process units 62 whose developing devices 62H and corresponding developer-accommodating devices 62G accommodating color toners can be integrally separated from the retaining case 65 as a unit are arranged toward the near side of the retaining case 65 relative to the pull-out direction. This structure of the process units 62 eliminates the opening and closing of shutters in the developer-accommodating devices 62G, thereby making replacement of the process units 62 easy and safe.

Among the developer accommodating devices 62G and the toner cartridge 100, the toner cartridge 100 can be replaced separately from the process unit 61. Since the toner cartridge 100 accommodates black toner, which is generally consumed faster than the color toners, this configuration can greatly reduce running costs.

The process unit 61 in which the toner cartridge 100 is detachably mounted is positioned inside the main body 10 when the retaining case 65 is pulled out to the second position. This arrangement greatly reduces the risk that forces applied to the retaining case 65 during operations to open and close shutters 120 and 220 when mounting and removing the toner cartridge 100 will cause damage to the retaining case 65 or overturn the main body 10 of the color multifunction device 1.

Further, when the retaining case 65 is pulled out and fixed in the second position, the process unit 61 in the retaining case 65 is supported in the main body 10 at two locations, i.e., the front side (the front supporting structure SF) and the rear side (the rear supporting structure SR). Therefore, operations for opening and closing the shutters 120 and 220 when mounting and removing the toner cartridge 100 can be performed more easily and safely.

While the invention has been described in detail with reference to the embodiment thereof, it would be apparent to those skilled in the art that many modifications and variations may be made therein without departing from the spirit of the invention, the scope of which is defined by the attached claims.

While the recording sheets described in the embodiment are paper P, such as normal paper or postcards, the recording sheets may also be transparencies or the like.

The specific structure and arrangement of other components constituting the image-forming device, such as the exposure device, retaining member, photosensitive drums, developer-accommodating devices, and operating member (handle), may be modified as desired and are not limited to the description in the above-mentioned embodiment.

Further, while the image-forming device with process units according to the present invention is the color multifunction device 1 in the embodiment, the image-forming device may also be a photocopier, printer, or the like. Also, the image-forming device of the embodiment includes four process units 61 and 62, but the present invention may be applied to any image-forming device having a plurality of developer-accommodating devices, including one that accommodates black developer.

What is claimed is:

1. An image forming device comprising:
a casing formed with an opening;
a plurality of photosensitive bodies;
a plurality of developing devices respectively corresponding to the plurality of photosensitive bodies;
a plurality of developer accommodating devices that accommodates and supplies developer respectively to the plurality of developing devices, a plurality of developer accommodating devices including a first developer accommodating device that is individually replaceable and separable from the corresponding developing device and a second developer accommodating device that is replaceable integrally together with the corresponding developing device; and
a retaining member that retains the plurality of photosensitive bodies arranged in an arrangement direction, the plurality of developing devices, and the plurality of developer accommodating devices at fixed positions in the casing, the retaining member being capable of being pulled out from the casing in the arrangement direction through the opening and being movable between a first position where the plurality of photosensitive bodies, the plurality of developing devices, and the plurality of developer accommodating devices are inside the casing and a second position where one of the plurality of developer accommodating devices located at most upstream side in the arrangement direction is replaceable,
wherein the one of the plurality of developer accommodating devices located at the most upstream side in the arrangement direction is the first developer accommodating device accommodating black developer, and each of the developer accommodating devices other than the one of the plurality of developer accommodating devices is the second developer accommodating device.

2. The image forming device according to claim 1, wherein the first developer accommodating device is formed with a supply opening for supplying the developer to the corresponding developing device, and the first developer accommodating device includes a shutter that selectively opens and closes the supply opening.

3. The image forming device according to claim 2, wherein the first developer accommodating device includes an operation unit that selectively switches the shutter between an open position at which the supply opening is open and a closed position at which the supply opening is closed, and the operation of the operation unit is in association with the engagement and disengagement between the first developer accommodating device and the corresponding developing device,
wherein the first developer accommodating device disengages from the corresponding developing device by switching the shutter to the closed position so that the first developer accommodating device is replaceable while the corresponding developing device is retained in the retaining member when the retaining member is at the second position,
wherein the first developer accommodating device engages with the corresponding developing device by switching the shutter to the open position when the retaining member is at the second position.

4. The image forming device according to claim 1, wherein the first developer accommodating device is located within the casing when the retaining member is at the second position.

5. The image forming device according to claim 4, wherein when the retaining member is at the second position, the retaining member is supported by the casing at least two locations, one location being at upstream side in the arrangement direction and the other location being at downstream side in the arrangement direction.

6. The image forming device according to claim 1, wherein the developer accommodated in the first developer accommodating device is a pulverized toner, and the developer accommodated in the second developer accommodating device is a chemical toner.
